(19) United States
(12) Patent Application Publication
(10) Pub. No.: US 2026/0362132 A1
(43) Pub. Date: Nov. 12, 2026

(54) METHODS, ARCHITECTURES, APPARATUSES AND SYSTEMS FOR INTEGRATED AND LEAN NON-3GPP ACCESS SECURITY

(71) Applicant: InterDigital Patent Holdings, Inc., Wilmington, DE (US)

(72) Inventors: Samir Ferdi, Kirkland, CA (US); Yi Zhang, San Jose, CA (US); Changgang Wang, Princeton, NJ (US); Zhibi Wang, Woodridge, IL (US); Alec Brusilovsky, Downingtown, PA (US)

(21) Appl. No.: 19/201,160

(22) Filed: May 7, 2025

(51) Int. Cl. H04W 12/06; H04W 12/0471; H04W 76/10

(52) U.S. Cl. CPC H04W 12/06; H04W 12/0471; H04W 76/10

(57) ABSTRACT

Methods, architectures, apparatuses, and systems directed to integrated and lean non-3GPP access security are described herein. In an embodiment, a first network element may establish a first secure communication channel with a wireless transmit/receive unit (WTRU) over an access network. The first network element may receive a first request message associated with multi-access binding (MAB) from the WTRU over the first secure communication channel. The first network element may send a first response message to the WTRU in response to the first request message, the first response message indicating an acceptance of the connection of the WTRU to the network via the access network. The first network element may establish a second secure communication channel with the WTRU over the access network within the first secure communication channel. The first network element may transfer traffic between the WTRU and the network over the second secure communication channel.

### TECHNICAL FIELD

The present disclosure is generally directed to the fields of communications, software and encoding, including methods, architectures, apparatuses, and systems directed to integrated and lean non-third generation partnership project (3GPP) access security.

### BACKGROUND

In NR (new radio), all non-access stratum (NAS) signaling between a wireless transmit/receive unit (WTRU) and the fifth generation (5G) core (5GC) terminates at the access and mobility management function (AMF) including non-3GPP (N3GPP) access using a non-3GPP interworking function (N3IWF). The WTRU may communicate with other 5GC network functions (NFs) using NAS transport via AMF by means of dedicated (e.g., session management) transparent containers, which AMF may forward using security keys derived during the WTRU primary authentication. Embodiments described herein have been designed with the foregoing in mind.

### SUMMARY

Methods, architectures, apparatuses, and systems directed to integrated and lean non-3GPP access security are described herein. In an embodiment, a first network element is described. The first network element may include circuitry including a transmitter, a receiver, a processor, and memory. The first network element may be configured to establish a first secure communication channel with a wireless transmit/receive unit (WTRU) over an access network for connection of the WTRU to a network. In various embodiments, the first network element may be connected to the network. The first network element may be configured to receive a first request message from the WTRU over the first secure communication channel. In various embodiments, the first request message may be associated with multi-access binding (MAB). In various embodiments, the first request message may include first identifying information. The first network element may be configured to send a second request message to a second network element. In various embodiments, the second request message may be associated with the MAB. In various embodiments, the second request message may include the first identifying information. The first network element may be configured to receive a second response message from the second network element in response to the second request message. In various embodiments, the second response message may include a security key and second identifying information. The first network element may be configured to send a first response message to the WTRU in response to the first request message. In various embodiments, the first response message may indicate an acceptance of the connection of the WTRU to the network via the access network based on the second response message indicating the security key. The first network element may be configured to establish a second secure communication channel with the WTRU over the access network based on the security key. In various embodiments, the second secure communication channel may be established within the first secure communication channel. The first network element may be configured to transfer traffic between the WTRU and the network via the access network over the second secure communication channel.

In an embodiment, a method implemented in a first network element is described. The method may include establishing a first secure communication channel with a wireless transmit/receive unit (WTRU) over an access network for connection of the WTRU to a network. In various embodiments, the first network element may be connected to the network. The method may include receiving a first request message from the WTRU over the first secure communication channel. In various embodiments, the first request message may be associated with multi-access binding (MAB). In various embodiments, the first request message may include first identifying information. The method may include sending a second request message to a second network element. In various embodiments, the second request message may be associated with the MAB. In various embodiments, the second request message may include the first identifying information. The method may include receiving a second response message from the second network element in response to the second request message. In various embodiments, the second response message may include a security key and second identifying information. The method may include sending a first response message to the WTRU in response to the first request message. In various embodiments, the first response message may indicate an acceptance of the connection of the WTRU to the network via the access network based on the second response message indicating the security key. The method may include establishing a second secure communication channel with the WTRU over the access network based on the security key. In various embodiments, the second secure communication channel may be established within the first secure communication channel. The method may include transferring traffic between the WTRU and the network via the access network over the second secure communication channel.

In an embodiment, a WTRU is described. The WTRU may include circuitry including a transmitter, a receiver, a processor, and memory. The WTRU may be configured to send a first message to a network. In various embodiments, the first message may be associated with multi-access binding (MAB). In various embodiments, the first message may indicate that a registration with the network may be requested. The WTRU may be configured to receive a second message from the network. In various embodiments, the second message may indicate a MAB identifier based on successful WTRU authentication. In various embodiments, the MAB identifier may identify a MAB context associated with the WTRU. The WTRU may be configured to establish a first secure communication channel with the network via an access network for connection to the network. The WTRU may be configured to send a first request message to the network via the first secure communication channel. In various embodiments, the first request message may indicate the MAB identifier. The WTRU may be configured to receive a first response message from the network in response to the first request message. In various embodiments, the first response message may indicate an acceptance of the connection via the access network. The WTRU may be configured to derive a security key using the MAB context and to establish a second secure communication channel with the network over the access network based on the security key. In various embodiments, the second secure communication channel may be established within the first secure communication channel. The WTRU may be configured to transfer traffic to the network via the access network over the second secure communication channel.

In an embodiment, a method implemented in a WTRU is described. The method may include sending a first message to a network. In various embodiments, the first message may be associated with multi-access binding (MAB). In various embodiments, the first message may indicate that a registration with the network may be requested. The method may include receiving a second message from the network. In various embodiments, the second message may indicate a MAB identifier based on successful WTRU authentication. In various embodiments, the MAB identifier may identify a MAB context associated with the WTRU. The method may include establishing a first secure communication channel with the network via an access network for connection to the network. The method may include sending a first request message to the network via the first secure communication channel. In various embodiments, the first request message may indicate the MAB identifier. The method may include receiving a first response message from the network in response to the first request message. In various embodiments, the first response message may indicate an acceptance of the connection via the access network. The method may include deriving a security key using the MAB context and establishing a second secure communication channel with the network over the access network based on the security key. In various embodiments, the second secure communication channel may be established within the first secure communication channel. The method may include transferring traffic to the network via the access network over the second secure communication channel.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example of non-roaming 5G system architecture;

FIG. 3 is a diagram illustrating an example of key hierarchy in 5G system (5GS);

FIG. 4 is a diagram illustrating an example of non-roaming architecture for non-3GPP access within evolved packet system (EPS);

FIG. 5 is a diagram illustrating an example of non-roaming architecture for 5G core network with untrusted non-3GPP access;

FIG. 6 is a diagram illustrating an example architecture to support authentication for non-seamless wireless local area network (WLAN) offload in 5GS;

FIG. 7 is a diagram illustrating a first example of hybrid architecture for integrated non-3GPP access communications with radio access network (RAN) using conventional N2 interface;

FIG. 8 is a diagram illustrating an example of evolved architecture for integrated non-3GPP access communications with RAN support for service-based interface (SBI);

FIG. 9 is a diagram illustrating an example key hierarchy for supporting integrated and lean non-3GPP access communications;

FIG. 10 is a diagram illustrating a first example procedure to establish a secure connection between the WTRU and the network over untrusted non-3GPP access;

FIG. 11 is a diagram illustrating a second example procedure to establish a secure connection between the WTRU and the network over untrusted non-3GPP access;

FIG. 12 is a diagram illustrating an example method for integrated and lean access security via a first non-3GPP access network and a second 3GPP access network, implemented in a WTRU;

FIG. 13 is a diagram illustrating an example method for integrated and lean access security via non-3GPP access, implemented in a WTRU; and

FIG. 14 is a diagram illustrating an example method for integrated and lean access security via non-3GPP access, implemented in a network element.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

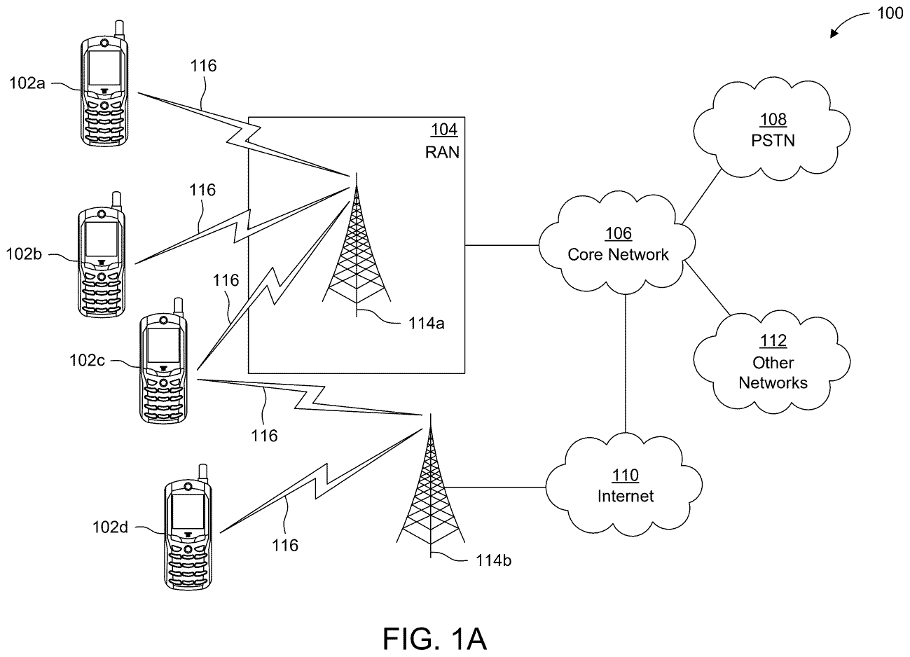

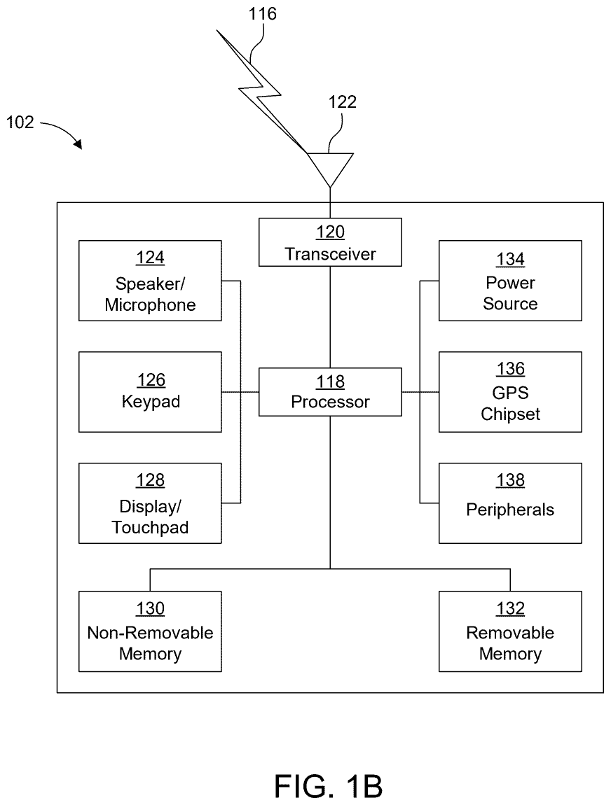

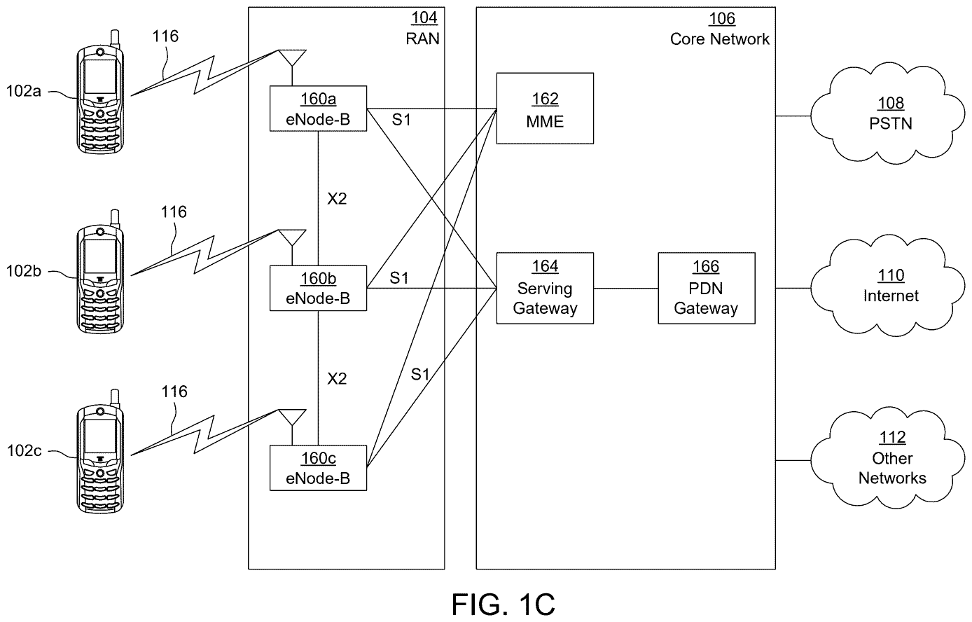

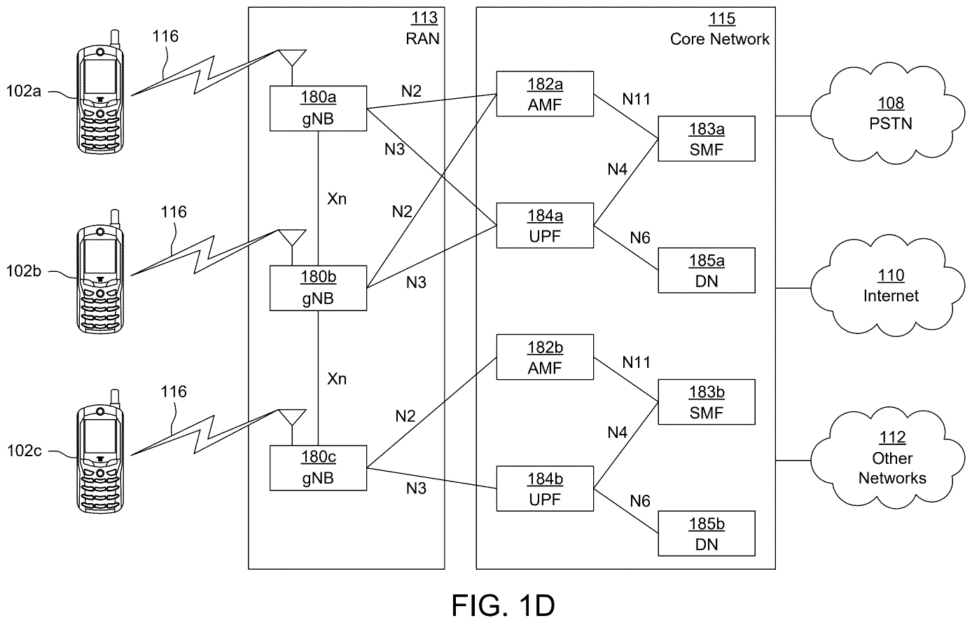

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized by WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Throughout embodiments described herein the terms “base station”, “network”, “cell”, and “gNB”, collectively “the network” may be used interchangeably to designate any network element such as e.g., a network element acting as a serving base station. Embodiments described herein are not limited to gNBs and are applicable to any other type of base stations.

For the sake of clarity, satisfying, failing to satisfy a condition, and configuring condition parameter(s) are described throughout embodiments described herein as relative to a threshold (e.g., greater, or lower than) a (e.g., threshold) value, configuring the (e.g., threshold) value, etc. For example, satisfying a condition may be described as being above a (e.g., threshold) value, and failing to satisfy a condition may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein, the expression “the WTRU may be configured with a set of parameters” is equivalent or may be used interchangeably with “the WTRU may receive configuration information (e.g., from another network element (e.g., gNB)) indicating a set of parameters”. Throughout embodiments described herein, the expressions “the WTRU may report something”, and “the WTRU may be configured to report something”, is equivalent or may be used interchangeably with “the WTRU may transmit (e.g., reporting) information indicating something”. Throughout embodiments described herein, the expression “the WTRU may provide (/be provided) with a set of parameters (/something)” is equivalent or may be used interchangeably with “the WTRU may transmit (/receive) information indicating a set of parameters (/something)”.

In embodiments described herein, “a” and “an” and similar phrases are to be interpreted as “one or more” and “at least one”. Similarly, any term which ends with the suffix “(s)” is to be interpreted as “one or more” and “at least one”. The term “may” is to be interpreted as “may, for example”.

A symbol “/” (e.g., forward slash) may be used herein to represent “and/or”, where for example, “A/B” may imply “A and/or B”.

In embodiments described herein, “list of”, “set of” and “one or more of” may be used interchangeably.

In embodiments described herein, “identity” and “identifier” may be used interchangeably to refer to how a network element (or a WTRU) may be identified.

In embodiments described herein, a network element may refer to any kind of device including computing resources and networking capabilities, that may be connected to a network. The terms network element and node may be used interchangeably. A network element may be any kind of network infrastructure device and or a WTRU. The architecture depicted at FIG. 1B for a WTRU 102 may be applicable more generally to any kind of network element.

Embodiments are described herein with a secure internet key exchange security association (IKE SA) communication channel as an example of secure communication channel (such as e.g., an IPSec tunnel) between a WTRU and a network element. The embodiments described herein are not limited to a secure IKE SA communication channel. Any kind of secure communication channel established between a WTRU and a network element and allowing to securely transmit any kind of information is applicable to the embodiments described herein.

Embodiments are described herein with IKE SA authentication request and response messages as examples of request and response messages to request and receive information to derive a security key in a multi-access binding situation. The embodiments described herein are not limited to IKE SA authentication request and response messages. Any kind of request and response messages (referred to herein as first request and first response messages) allowing to request and receive information to derive a security key in a multi-access binding situation are applicable to the embodiments described herein.

Embodiments are described herein with a sixth generation (6G) packet data gateway (6G PDG) as an example of network element to perform network operations a multi-access binding situation. The embodiments described herein are not limited to a 6G PDG network element. Any kind of network element (referred to herein as first network element) allowing to perform network operations in a multi access-binding situation is applicable to the embodiments described herein.

In embodiments described herein the terms “untrusted non-3GPP access”, “non-3GPP access”, ‘untrusted access network”, “untrusted non-3GPP access network” and “non-3GPP access network” may be used interchangeably.

A WTRU secure connection establishment with a 6G PDG over untrusted non-3GPP access is described herein.

In an example, a 6G PDG may establish non-3GPP access connection security with a WTRU based on a security key derived from a multi-access binding (MAB) context established following a successful primary authentication during any of WTRU current and prior access.

A 6G PDG behavior is described herein.

The 6G PDG may establish a (e.g., first) secure IKE SA communication channel with the WTRU (e.g., IKE SA may be set up using IKE_SA_INIT request/response messages). For example, the 6G PDG may establish the (e.g., first) secure IKE SA communication channel with the WTRU over an access network for connection of the WTRU to the network, the 6G PDG being connected to the network. The access network may be, for example, an untrusted non-3GPP access network.

The 6G PDG may perform WTRU authentication and key agreement based on any of a first example (e.g., where the WTRU may have an existing security context with the public land mobile network (PLMN)) and a second example where the WTRU may not have an existing security context with the PLMN).

In any of the first and second examples, the 6G PDG may receive a first request message from the WTRU over the (e.g., first) secure communication channel, the first request message being associated with multi-access binding, the first request message including first identifying information. The 6G PDG may send a second request message to a (e.g., second) network element, the second request message being associated with multi access binding, the second request message including the first identifying information. The 6G PDG may receive a second response message from the (e.g., second) network element, in response to the second request message, the second response message including a security key and second identifying information. The 6G PDG may send a first response message to the WTRU in response to the first request message, the first response message indicating an acceptance of the connection of the WTRU to the network via the access network based on the second response message indicating the security key.

In the first example, (e.g., where the WTRU may have an existing security context with the PLMN), the 6G PDG may receive from the WTRU a (e.g., first request) message (e.g., IKE_AUTH req) including a multi-access binding identifier (MAB ID), e.g., as first identifying information.

In the first example, the 6G PDG may determine that the WTRU may have an existing security context with the (e.g., core) network based on the MAB ID.

In the first example, the 6G PDG may locate (e.g., determine) a WTRU MAB context holding NF (e.g., any of a security anchor function (SEAF), an AMF, a WTRU context function (UCF)) using the MAB ID (e.g., using any of a network repository function (NRF) and NF information included the MAB ID).

In the first example, the 6G PDG may (e.g., send a second request message that may) request a security key (K_{6G PDG}) from the WTRU MAB context holding NF providing (e.g., indicating) the MAB ID.

In the first example, the 6G PDG may receive from the WTRU MAB context holding NF (e.g., a second response message indicating) the security key (K_{6G PDG}) and a subscription permanent identifier (SUPI) of the WTRU (e.g., as second identifying information)

In the second example, (e.g., where the WTRU may not have an existing security context with the PLMN), the 6G PDG may receive from the WTRU a (e.g., first request) message (e.g., IKE_AUTH req) that may not include any MAB ID (e.g., including a WTRU identifier (ID), e.g., as first identifying information).

In the second example, the 6G PDG may determine that there may be no existing security context for the WTRU in the (e.g., core) network based on receiving a WTRU ID (e.g., a subscription concealed identifier (SUCI)) and no MAB ID from the WTRU.

In the second example, the 6G PDG may initiate WTRU primary authentication and authorization over the service-based interface (SBI) with any of an authentication server function (AUSF) and a unified data management (UDM) e.g., extensible authentication protocol (EAP) authentication and key agreement (AKA) directly or via an anchor NF (e.g., SEAF).

In the second example, the 6G PDG may forward back and forth authentication messages between the WTRU and AUSF over the (e.g., first) secure communication channel and SBI.

In the second example, the 6G PDG may receive a security key (K_{6G PDG}) and SUPI of the WTRU from the anchor or authentication NF and a new MAB ID (e.g., as second identifying information), based on a successful WTRU authentication.

In the second example, the 6G PDG may send the MAB ID to the WTRU in a message (e.g., IKE AUTH response).

In any of the first and the second examples, the 6G PDG may establish an IPSec child SA (within IKE SA secure channel described above) with WTRU based on K_{6G PDG}. The IPSec child SA may be referred to herein as second secure communication channel. For example, the second secure communication channel may be established over the first access network within the first secure communication channel.

In any of the first and the second examples, the 6G PDG may transfer (e.g., any of control plane (CP) and user plane (UP)) traffic between the WTRU and the (e.g., 6GC) network (e.g., WTRU and NF or WTRU and data network (DN)) over the secure non-3GPP access connection.

A WTRU behavior (e.g., 3GPP access with subsequent non-3GPP access) is described herein.

The WTRU may perform authentication and key agreement during 3GPP access registration with a PLMN, including, for example, any of (i) sending a (e.g., first) message (e.g., registration) to the network (AMF) indicating multi-access binding capabilities, (ii) performing primary authentication and authorization with the network (AMF/SEAF, AUSF), (iii) receiving from the network a (e.g., second) message including a MAB ID, based on successful WTRU authentication, (iii) storing the MAB ID locally along with a network access counter (NAC) in a MAB context associated with the PLMN (e.g., set to/incremented to a value (e.g., 1)). In an example, the WTRU may send a first message to a network, the first message being associated with multi access binding, the first message indicating that a registration with the network may be requested. In an example, the WTRU may receive a second message from the network, the second message indicating a MAB identifier based on successful WTRU authentication, the MAB identifier identifying a MAB context associated with the WTRU.

The WTRU may access the PLMN via non-3GPP access 6G PDG, including, for example, any of (i) performing 6G PDG selection procedure (e.g., constructing a fully qualified domain name (FQDN) based on any of configuration and domain name system (DNS) based discovery), (ii) establishing a (e.g., first) secure IKE SA communication channel with the 6G PDG (e.g., IKE SA may be set up using IKE_SA_INIT request/response) e.g., over an (e.g., untrusted) access network for connection to the network, (iii) locating a MAB context associated with the 6G PDG PLMN and retrieving a MAB ID from the context, (iv) sending a (e.g., first request) message (e.g., IKE_AUTH request) to the 6G PDG, including the MAB ID, and (v) receiving a (e.g., first response) message (e.g., IKE_AUTH response) from the 6G PDG, with acceptance of access (e.g., including EAP-success). For example, the (e.g., first response) message may indicate acceptance of the connection via the (e.g., untrusted access network).

The WTRU may derive a K_{6G PDG} using an anchor key (e.g., KSEAF) from prior access, and NAC (incremented to a value (e.g., 2)). In an example, the WTRU may derive a security key (K_{6G PDG}) using the MAB context.

The WTRU may establish an IPSec Child SA (within (e.g., first) IKE SA secure channel described above) with 6G PDG based on K_{6G PDG}.

The WTRU may communicate with 6GC NFs or data network (DN) via 6G PDG over the secure non-3GPP access connection.

The WTRU may transfer packets with network/DN.

NAS signaling and security are described herein.

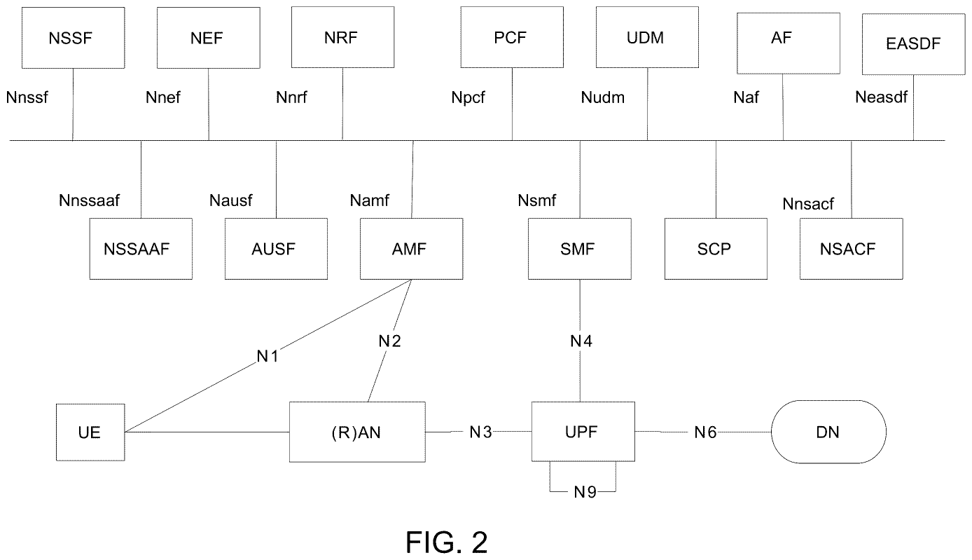

FIG. 2 is a diagram illustrating an example of non-roaming 5G system architecture.

In the current system, (e.g., all) NAS signaling between a WTRU and the 5GC may terminate at the AMF (shown as the N1 interface in FIG. 2) including non-3GPP access using an N3IWF. The WTRU may communicate with other 5GC NFs (e.g., SMF) using NAS transport via AMF by means of dedicated (e.g., session management (SM)) transparent containers, which AMF may forward using the SBI (e.g., invoking, for example the Nsmf service).

The NAS connection between the WTRU and AMF may be secured using NAS keys (any of K_{NASint}, K_{NASenc}) derived from a K_{AMF} established during WTRU primary authentication.

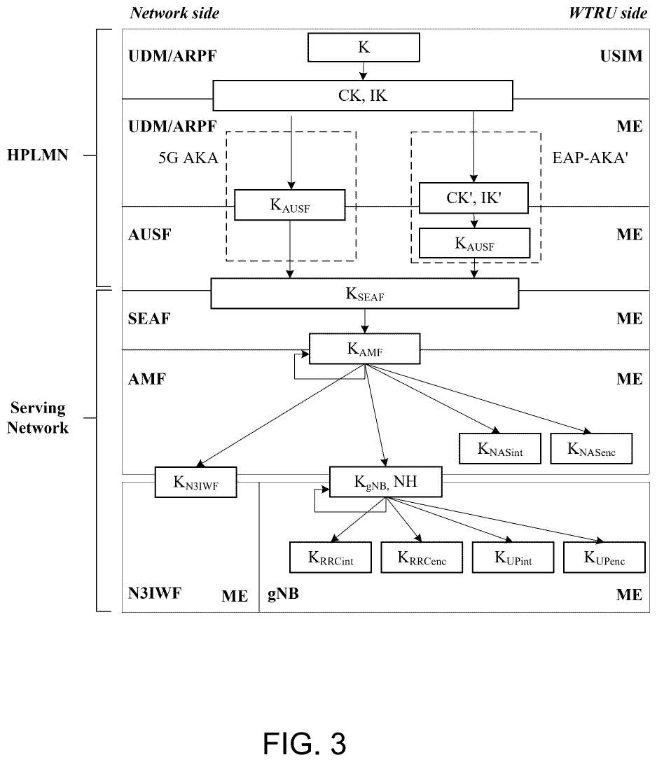

FIG. 3 is a diagram illustrating an example of key hierarchy in 5GS.

The key hierarchy may include the following keys: K_{AUSF}, K_{SEAF}, K_{AMF}, K_{NASint}, K_{NASenc}, K_{N3IWF}, K_{gNB}, K_{RRCint}, K_{RRCenc}, K_{UPint} and K_{UPenc}. Keys related to access stratum (e.g., key for NG-RAN, keys for user plane (UP) traffic, keys for radio resource control (RRC) signaling and intermediate keys) are described herein.

Key for NG-RAN may include K_{gNB}, which is a key that may be derived by the mobile equipment (ME) and AMF from K_{AMF}. The K_{gNB} may be used as K_{eNB} between ME and ng-eNB.

Keys for UP traffic may include K_{UPenc} and K_{UPint}. K_{UPenc} is a key that may be derived by ME and gNB from K_{gNB}, which may (e.g., only) be used for the protection of UP traffic with a particular encryption algorithm. K_{UPint} is a key that may be derived by ME and gNB from K_{gNB}, which may (e.g., only) be used for the protection of UP traffic between ME and gNB with a particular integrity algorithm.

Keys for RRC signaling may include K_{RRCint} and K_{RRCenc}. K_{RRCint} is a key that may be derived by ME and gNB from K_{gNB}, which may (e.g., only) be used for the protection of RRC signaling with a particular integrity algorithm. K_{RRCenc} is a key that may be derived by ME and gNB from K_{gNB}, which may (e.g., only) be used for the protection of RRC signaling with a particular encryption algorithm.

Non-3GPP access in 4G is described herein.

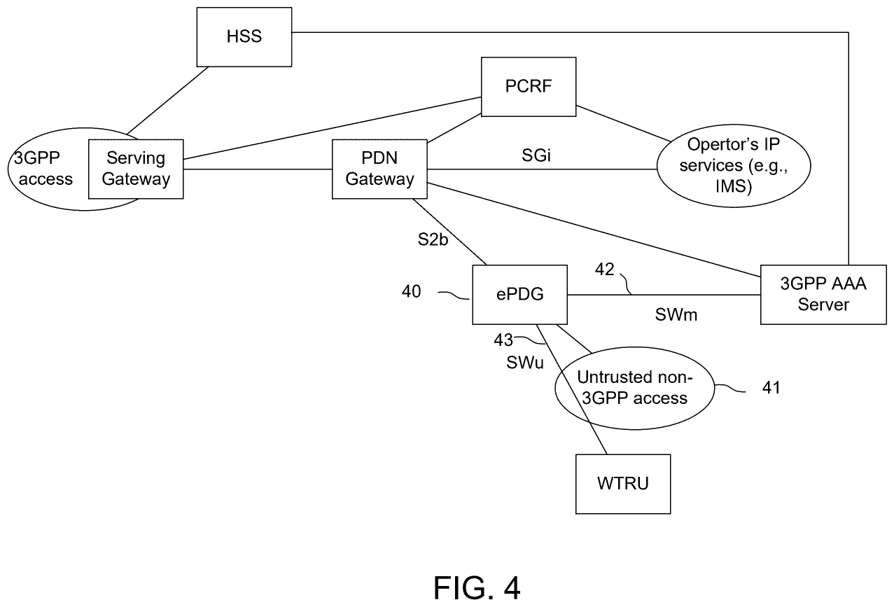

FIG. 4 is a diagram illustrating an example of non-roaming architecture for non-3GPP access within evolved packet system (EPS). In the fourth generation (4G), third generation partnership project (3GPP) introduced the evolved packet data gateway (ePDG) 40, shown in FIG. 4, which may act as a secure gateway for untrusted non-3GPP access 41.

In an example, ePDG 40 may allow operators to deploy IP multimedia sub-system (IMS) voice over Wi-Fi service (VoWiFi).

In an example, a WTRU and ePDG may perform mutual authentication procedure (EAP-AKA) using a diameter interface (SWm) 42 with a 3GPP authentication authorization accounting server (AAA) communicating with a home subscriber server (HSS).

In an example, the communication between the WTRU and the ePDG 40 may be secured by an IPSec tunnel established using IKEv2 (over SWu reference point 43).

Non-3GPP access in 5G is described herein.

In fifth generation (5G), 3GPP introduced the N3IWF with the goal of enabling an access agnostic core network.

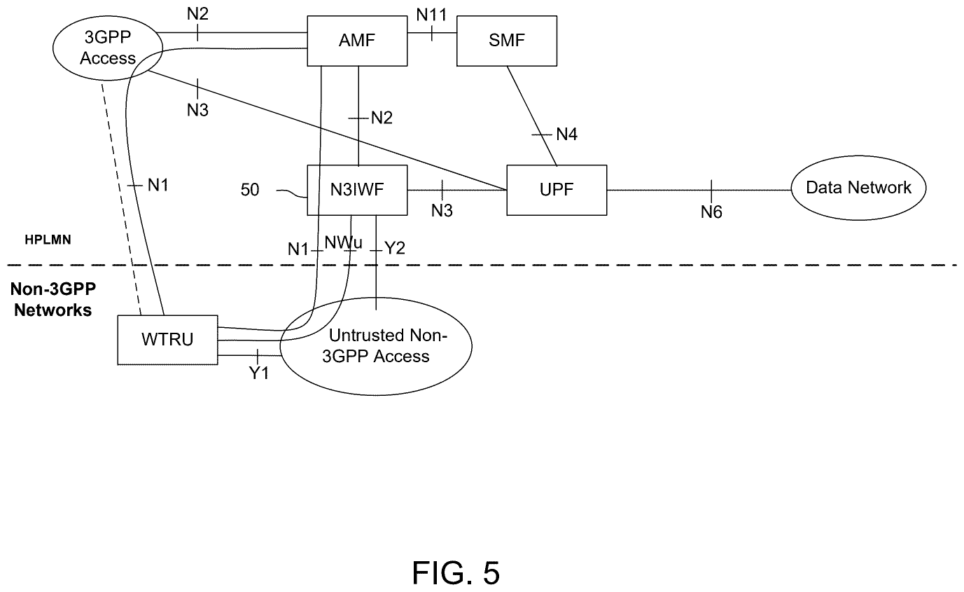

FIG. 5 is a diagram illustrating an example of non-roaming architecture for 5G core network with untrusted non-3GPP access.

In an example, N3IWF 50 in the 5GC may interface with AMF (via N2) and UPF (via N3) to enable interworking between 3GPP and non-3GPP for data communications.

In an example, a WTRU and N3IWF 50 may perform a mutual authentication procedure (EAP-AKA) using AMF as authenticator communicating with AUSF/UDM.

In an example, the communication between the WTRU and N3IWF 50 may be secured by an IPSec tunnel established using IKEv2 (over Nwu reference point).

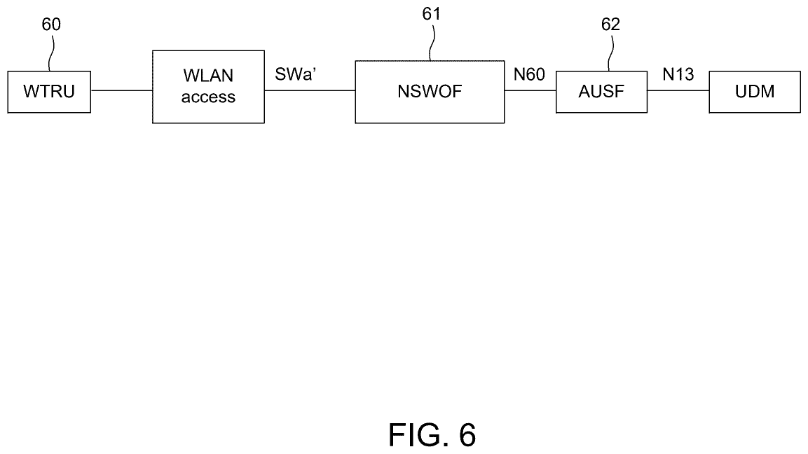

FIG. 6 is a diagram illustrating an example architecture to support authentication for non-seamless WLAN offload in 5GS.

Support for WLAN connection using 5G credentials and without 5GS registration was added in the 5GS. As illustrated in FIG. 6, a non-seamless WLAN offload function (NSWOF) 61 may interface with the AUSF 62 using SBI to perform authentication and authorization of the WTRU 61. This may be seen as a non-integrated (e.g., “non-seamless”) solution with 5GC, whereby the WTRU may route user traffic via WLAN access without traversing the 5GC.

Potential enhancements to ePDG to support VoWiFi using 5GC architecture (e.g., using AUSF/UDM without intermediate AAA server) may be considered for further 5G releases, e.g., including how to enable 3GPP-N3GPP interworking without the use of N3IWF.

Existing non-3GPP access solutions may be using ePDG or N3IWF, which may present pros and cons, which are described herein.

For the ePDG based solution, pros may include being the only solution deployed in the market for VoWiFi service.

For the ePDG based solution, cons may include (i) requiring separate authentication frameworks between 3GPP and N3GPP access, which may lead to excess signaling e.g., in mobility scenarios, (ii) requiring non-stand-alone (NSA) network deployment (e.g., using evolved packet core (EPC)) which may not be acceptable for a number of mobile network operators (MNOs) that may be transitioning towards using a 5GC, and (iii) the usage of the legacy diameter interface not allowing MNO to leverage more modern SBI based architecture for sought after CAPEX/OPEX reduction.

For the N3IWF based solution, pros may include (i) common NAS 3GPP and non-3GPP access allowing WTRU to be authenticated only once by AMF for both accesses, and (ii) providing means for an access-agnostic core (e.g., knowing that AMF may (e.g., need to) be aware of the access used by the WTRU).

For the N3IWF based solution, cons may include (i) added complexity on WTRU and network side due to tight coupling of non-3GPP access with AMF (e.g., based on the need for the AMF to be aware of the access used by the WTRU and based on several NAS features remaining access specific (e.g., paging, power saving modes being 3GPP access specific) requiring NAS procedures to be adapted accordingly), and (ii) the lack of WTRU vendor support leading to the lack of successful commercial deployment.

The embodiments described herein enable a leaner solution for non-3GPP access integration in the (e.g., 6G) system.

The embodiments described herein aim at avoiding complexities as exemplified by the N3IWF based approach (e.g., due to tight coupling with AMF) to ease the deployment on the WTRU and network side.

The embodiments described herein aim at aligning with a more modern (e.g., SBI based and not requiring additional functionality such as 3GPP AAA) architecture for CAPEX/OPEX reduction (e.g., in contrast to current ePDG).

The embodiments described herein provide at least a similar level of security to existing solutions (ePDG, N3IWF).

Embodiments are described herein where the system (which may be referred to as sixth generation system (6GS)) may enable secure communication over non-3GPP between a WTRU and the core Network (referred to as 6GC, or simply “network”). The WTRU may establish a secure connection with a 6G PDG based on successful primary authentication performed as part of current network access/registration procedure or based on a result from a prior successful network access procedure.

The storage and maintenance of the access specific security context(s) may be offloaded from the AMF to one or more of the NFs. The 6G PDG may establish non-3GPP access security that may be (e.g., loosely) coupled with 3GPP access security (using a WTRU multi-access binding context), independent of AMF and the associated NAS (security context). Embodiments described herein may allow usage of leaner non-3GPP access authentication and authorization procedures on the WTRU and the network side, to address the complexity stemming from the current N3IWF solution. Using a secure connection established with the 6G PDG, the WTRU may be able to establish secure communications (over CP or UP) directly with NFs in the 6GC via 6G PDG, and independently from the AMF.

The 6G PDG may leverage the SBI interface and WTRU primary authentication methods taking advantage of PLMN credentials in the universal subscriber identity module (USIM) e.g., based on 5G authentication procedures. Embodiments described herein may allow for the reuse of a robust and secure common authentication framework to provide operators with CAPEX/OPEX reduction opportunities, to address the limitations of the current ePDG solution.

An architecture for integrated non-3GPP access is described herein.

Two system architecture examples to support integrated and lean non-3GPP access are described herein.

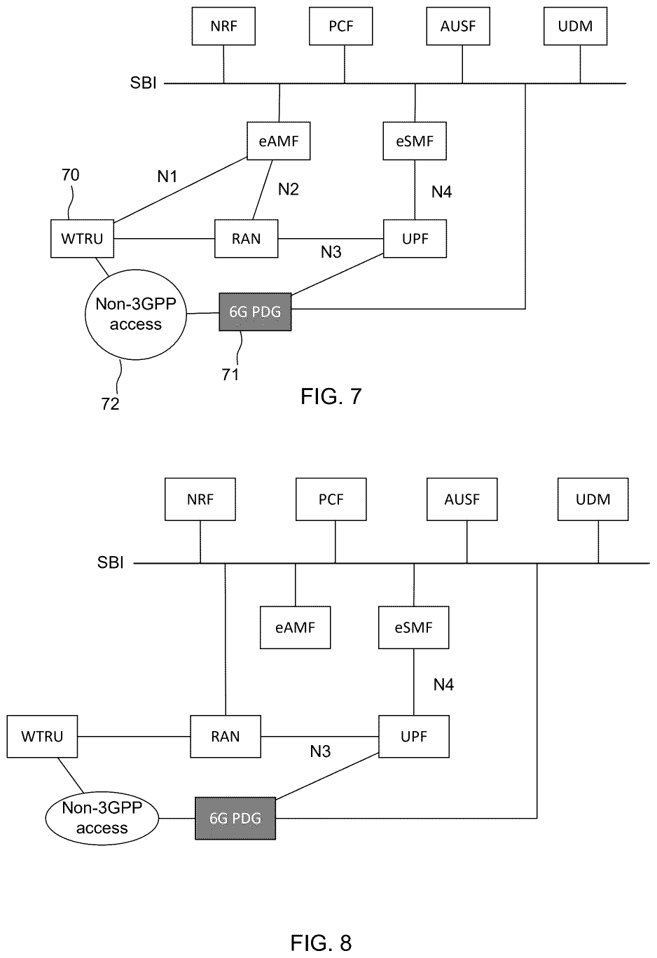

FIG. 7 is a diagram illustrating a first example of hybrid architecture for integrated non-3GPP access communications with RAN using conventional N2 interface. The WTRU 70 may use a conventional N1 interface for CP-terminated communication with legacy/evolved 5GS functions (e.g., any of mobility management (MM), session management (SM), policy control function (PCF)). The WTRU 60 may communicate via non-3GPP access 72 using a 6G PDG 71 network function (described herein).

FIG. 8 is a diagram illustrating an example of evolved architecture for integrated non-3GPP access communications with RAN support for SBI. A difference with the hybrid architecture shown at FIG. 7 may include that the WTRU may use RAN as an SBI gateway for 3GPP access CP-terminated communications.

The 6G PDG is described herein.

The 6G PDG introduced in the architecture described above may provide any of the following functionalities.

In an example, the 6G PDG may provide a security termination point (e.g., IPSec tunnel endpoint) for a WTRU connecting via non-3GPP access network.

In an example, the 6G PDG may perform authentication and authorization procedures for a WTRU connecting via non-3GPP access network.

In an example, the 6G PDG may support (e.g., direct) SBI access for direct interactions with NFs and decoupled from AMF. The operations that the 6G PDG may perform over SBI may include initiating WTRU authentication and authorization with AUSF/UDM or via anchor function (e.g., SEAF). The operations that the 6G PDG may perform over SBI may include retrieval of WTRU security context information from a WTRU MAB context holding NF (e.g., SEAF, UCF) to allow 6G PDG to derive non-3GPP access security context from an existing security context (e.g., for 3GPP access). In that case, the 6G PDG may skip reauthentication of WTRU, for example, if the WTRU is already authenticated and authorized via another access. The operations that the 6G PDG may perform over SBI may include forwarding end to end (E2E) e.g., UP and/or CP traffic between WTRU and 6GC NFs (over SBI or via UPF). For example, the 6G PDG may route data packets between WTRU and DN or NF via UPF or CP messages between the WTRU and NFs via SBI.

In an example, the WTRU may connect with a 6G PDG that may reside in any of the home PLMN (HPLMN) and the visited PLMN (VPLMN).

In an example, the 6G PDG may be co-located with UPF.

In an example, the WTRU may discover the 6G PDG using any kind of procedures (e.g., using 6G PDG configured or constructed FQDN, DNS based discovery).

In an example, the 6G PDG may support a reallocation procedure. For example, the WTRU may connect with a first 6G PDG to access one or more network slices. If the first 6G PDG is not compatible with one or more network slices, the 6G PDG may initiate a re-allocation towards a second 6G PDG. The first 6G PDG may send to the WTRU a rejection message with, for example, a cause code indicating that the first 6G PDG may not be appropriate for the one or more network slices and including information about the second 6G PDG (e.g., FQDN). The WTRU may use the received information to reconnect with the second 6G PDG.

Key hierarchy for integrated non-3GPP access is described herein.

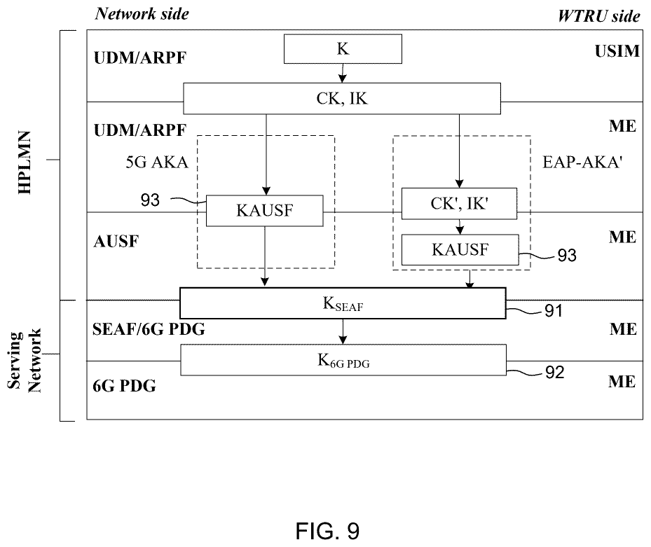

FIG. 9 is a diagram illustrating an example key hierarchy for supporting integrated and lean non-3GPP access communications. In an example, the key hierarchy shown at FIG. 9 may be for E2E communications between WTRU and NF in VPLMN.

Following a successful primary authentication performed by the WTRU with the 6G PDG, the 6G PDG (acting as an authenticator) may receive an anchor key K_{SEAF} 91. In an example, the 6G PDG may derive a K_{6G PDG} 92 using K_{SEAF} 91. An example of a key derivation function (KDF) for K_{6G PDG} 92 may be: K_{6G PDG}=KDF (K_{SEAF}, parameters) where parameters may include any of a (i) WTRU ID (e.g., SUPI) where WTRU ID may comprise a long-term identity of the WTRU, (ii) a network access counter (NAC), and an access type identifier (e.g., non-3GPP access). In another example, the SEAF acting as the authenticator on behalf of 6G PDG, may derive K_{6G} PDG and may send it to 6G PDG.

In another example, the K_{6G PDG} may be derived by AUSF using K_{AUSF} 93. The parameters used in the key derivation may include the serving network name in addition to any of the above-described parameters.

In an example, a WTRU may connect with 6G PDG and may already be authenticated and authorized in the PLMN (e.g., over 3GPP access). The 6G PDG may request a K_{6G PDG} from a WTRU MAB context holding function (e.g., any of SEAF, UCF, AUSF). The WTRU MAB context holding function may derive K_{6G PDG} as described above. The 6G PDG may skip the WTRU primary authentication in this case. How the 6G PDG may locate the serving AUSF/SEAF/UCF and the associated mechanism for binding multiple accesses in the WTRU and the network are described later herein.

In an example, the WTRU may perform a similar derivation of K_{6G PDG} following successful acceptance of connectivity with 6G PDG (with or without primary authentication performed with 6G PDG). WTRU and 6G PDG may use K_{6G PDG} to establish communication security (e.g., an IPSec Child SA as part of the IPSec tunnel).

Multi-access binding (MAB) is described herein.

A loose coupling between 3GPP and non-3GPP access contexts may be enabled by the WTRU and the network using a WTRU multi-access binding (MAB) context. The WTRU MAB context may apply in a (e.g., given) PLMN and may contain information related to the various (e.g., different) accesses networks the WTRU may be actively using (e.g., any of 3GPP, Wi-Fi, non-terrestrial network (NTN)) in the PLMN.

A MAB context is described herein.

The MAB context may be stored in the WTRU and the network and may include or may be associated with any of the following parameters.

In an example, (for the WTRU and the network) the MAB context may include or may be associated with a (e.g., unique) multi-access binding identifier (MAB ID). The MAB ID may be unique per PLMN and may be used to locate serving NF that may maintain the MAB context in the network. In an example, the MAB ID may be allocated by the network and sent to the WTRU based on successful network access. In another example, the MAB ID may be generated by the WTRU and the network using a (e.g., standardized, common, shared) derivation function.

The MAB ID may include any of the following information elements.

In a first example of information element, the MAB ID may include a PLMN ID where the WTRU may be connecting via multi-access.

In a second example of information element, the MAB ID may include routing information such as e.g., a routing identifier. For example, a routing identifier may include any of a uniform resource identifier (URI)) and NF identification information used to locate the NF that may maintain the MAB context.

In a third example of information element, the MAB ID may include information about the one or more access types being used by WTRU. For example, a bit may be set for an access type in use by WTRU. One or more bits may be set simultaneously in the MAB ID to indicate the one or more access types being used by WTRU. In another example, information about the one or more access types being used by WTRU may be stored as separate information elements in the MAB context as described here-below.

In a fourth example of information element, the MAB ID may include a (e.g., random) number used by the network to (e.g., uniquely) identify and locate the MAB context associated with the WTRU. This part of the MAB ID may be derived using any of a key (e.g., any of K_{SEAF}, K_{AUSF}), the WTRU ID (SUPI) and NAC to ensure collision free MAB ID allocation within the PLMN. In another example, the network may have its own mechanism to ensure MAB-ID uniqueness, e.g., by verifying that the randomly selected MAB-ID may be unique against the existing set of MAB-IDs.

In an example, (for network side) the MAB context may include or may be associated with a WTRU ID (e.g., SUPI) that may identify the WTRU associated with the MAB context.

In an example, (for the WTRU and the network) the MAB context may include or may be associated with a list of access types that the WTRU may currently be using (in addition or alternatively to the information encoded in the MAB ID).

In an example, (for the WTRU and the network) the MAB context may include or may be associated with a network access counter (NAC): The WTRU and the network may increment the NAC, after (e.g., each time) the WTRU may successfully connect via a (e.g., new) access network. The NAC may be used to generate a fresh key K_{6G PDG}. The NAC may be used to generate a part of the fresh MAB ID as described here-above.

In an example, (for the network side) the MAB context may include or may be associated with one or more NF IDs that may identify the NFs or NF instances that may currently be providing the WTRU with an access anchor point in the core network (e.g., 6G PDG, AMF).

In an example, (for the WTRU and the network) the MAB context may include or may be associated with the access specific keys (e.g., K_{6G PDG}, K_{AMF}) e.g., along with anchor or intermediate key (e.g., K_{SEAF}, K_{AUSF}) used to generate access specific keys. The maintenance of the keys may be governed by their respective access key lifecycle and may be updated accordingly at any time. For example, the keys may be rekeyed or refreshed following a WTRU re-authentication or deleted when (e.g., after) WTRU may de-register from the corresponding access network.

In an example, (for the network side) the MAB context may include or may be associated with a timestamp indicating last time the MAB context may have been refreshed. The time stamp may indicate last time a fresh key obtained from a WTRU authentication may have been stored in the MAB context. For example, when an NF (e.g., 6G PDG) completes the WTRU (re)authentication for a given access it may store (e.g., update) the timestamp to current time in the MAB context. This information may be used by an NF (e.g., AMF) to determine (e.g., based on operator) whether to use MAB context to derive (e.g., 3GPP) access keys or initiate a new WTRU authentication (e.g., if prior access keys are deemed not “fresh enough”).

MAB context management is described herein.

Different variants may be supported for the storage of the MAB context:

In an example, the NF that may perform the (e.g., initial) primary authentication (regardless of access) may store the MAB context. For example, any of the AMF, SEAF, 6G PDG and AUSF that may perform an initial authentication of the WTRU may create the MAB context and may store it locally or may store it using the service of a WTRU MAB context holding NF e.g., together with the corresponding MAB-ID.

In an example, WTRU MAB context holding NF may be realized by an access-independent data or context storage NF similar to a WTRU context function (UCF) or UDM/UDR and may store the MAB context. For example, the NF that may authenticate the WTRU the first time may request the UCF or UDM/UDR for the creation and storage of the MAB context.

In an example, the WTRU MAB context holding NF may register the associated MAB ID as part of its profile in the NRF together with the type of context management that it may be capable of providing (e.g., any of adding/removing a particular access, aiding other NFs in soft inter-access handovers). A network access anchor NF (e.g., AMF, 6G PDG) may (e.g., then) use the NRF to locate the NF that may any of hold, maintain, and be capable of using WTRU MAB context in a particular way. In another example, the WTRU MAB context holding NF may be located by the anchor NF using NF identification part of the MAB ID directly (e.g., NF ID and/or routing ID, as described herein).

In an example, the WTRU MAB context holding NF may update the MAB context based on a change occurring for WTRU multi-access connections. For example, when the WTRU connects via a (e.g., new) network access, the NF may increment the NAC and may add the associated access type to the list of access types upon (e.g., based on) receiving a corresponding message from network access anchor NF (e.g., 6G PDG). In another example, when the WTRU disconnects from one of the accesses, the NF may remove the associated access type from the list of access types upon (e.g., based on) receiving a corresponding message from network access anchor NF (e.g., 6G PDG). The NF may delete the MAB context when (e.g., after) the WTRU may be disconnected (e.g., de-registered) from (e.g., all) accesses. In another example, the NF may replace the deleted access context with NULL value, for example, if the expectation is that the WTRU may return to that particular access.

MAB ID privacy is described herein.

Privacy aspects regarding the MAB ID are described herein. To mitigate potential tracking attacks based on MAB ID, a fresh MAB ID may be generated by the network (and WTRU) (e.g., periodically and/or based on events such as when the WTRU connects via a new access network). For example, a man in the middle (MiTM) may potentially intercept the MAB ID as part of the IPSec connection establishment (e.g., after IKE SA setup in the IKE AUTH and may not complete first child SA setup). A new random part of the MAB ID may be generated in addition to the update of other fields (e.g., access type bits) such as to mitigate potential tracking of the MAB ID across subsequent network access procedures.

WTRU connection establishment with 6G PDG (with an existing MAB context) is described herein.

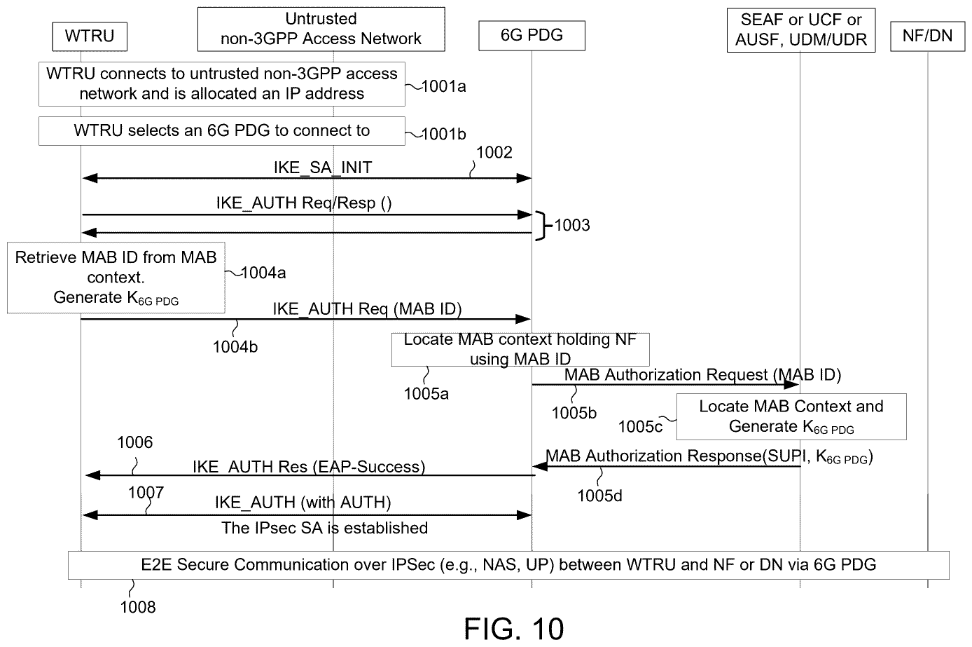

FIG. 10 is a diagram illustrating a first example procedure to establish a secure connection between the WTRU and the network over untrusted non-3GPP access using a 6G PDG as a network access security termination point. In the first example procedure, the WTRU may have already established a MAB context with the network.

For example, a pre-condition of the first example procedure may include that the WTRU may have successfully connected via another (e.g., 3GPP) access network and may have established a MAB context with the PLMN.

As shown at 1001a, the WTRU may connect to an untrusted non-3GPP access network (e.g., Wi-Fi). As shown at 1001b, the WTRU may select a 6G PDG in the PLMN based on any of 6G PDG configuration information in the WTRU, a discovery (e.g., DNS based) procedure, the WTRU location.

As shown at 1002, the WTRU may establish an IKE security association (SA) with the 6G PDG using initial messages (IKE_SA_INIT request/response) such as e.g., in an IKEv2 protocol. The subsequent IKE messages exchanged may be (e.g., full) protected using the established IKE SA.

As shown at 1003, the WTRU may initiate the IPSec SA establishment with the 6G PDG by initiating an IKE_AUTH exchange. For example, the WTRU may send an IKE_AUTH request message to the 6G PDG which may respond with an IKE_AUTH response message. The WTRU may validate the 6G PDG credentials (e.g., certificate or based on a pre-shared key (PSK)) in the IKE_AUTH response message from the 6G PDG.

As shown at 1004a, the WTRU may locate a locally stored MAB context associated with the PLMN. The WTRU may retrieve the MAB ID from the MAB context and may send (e.g., include) the MAB ID to the 6G PDG in a first request message (such as e.g., an IKE_AUTH request message) as shown at 1004b. The WTRU may generate a K_{6G} PDG using the MAB context information as described herein relatively to key derivation, at this operation level (shown at 1004) or in a subsequent operation (e.g., operation shown at 1006). The WTRU may generate a message authentication code (MAC) (referred to herein as MAB-MAC-I_{WTRU}) using any of a key from the MAB context (e.g., K_{SEAF} or K_{6G PDG}), the NAC and the MAB ID for authentication and integrity check of the MAB ID by the network. The WTRU may include the MAB-MAC-I_{WTRU} (e.g., in the IKE_AUTH request message) along with the MAB ID.

As shown at 1005a, the 6G PDG may locate the MAB context holding NF (e.g., any of SEAF, UCF, UDM/UDR) using the received MAB ID. For example, the 6G PDG may request an NRF for the ID of the NF, providing the NRF with the MAB ID. In another example, the 6G PDG may locate the NF directly based on any of NF routing information and NF identification information in the MAB ID.

As shown at 1005b, the 6G PDG may send the MAB ID and MAB-MAC-I_{WTRU} to the selected MAB context holding NF in second request message (such as e.g., a MAB authorization request message).

As shown at 1005c The MAB context holding NF may locate the MAB context using the MAB ID. The MAB context holding NF may generate a message authentication code (referred to herein as MAB-MAC-I_{NF}) using the same parameters as the WTRU may have used to generate MAB-MAC-I_{WTRU} in operation shown at 1004a. The MAB context holding NF may compare MAB-MAC-I_{NF} with MAB-MAC-I_{WTRU} to verify that the request is from the authorized WTRU. The NF may generate a K_{6G PDG} using the MAB context information as described herein relatively to key derivation.

As shown at 1005d, the MAB context holding NF may send a second response message (such as e.g., an authorization response message) to the 6G PDG indicating any of the WTRU ID and the K_{6G PDG}.

As shown at 1006, the 6G PDG may send a first response message (such as e.g., an IKE_AUTH response message) to the WTRU including/indicating acceptance of the connection, for example, if a K6G PDG is successfully received from the MAB context holding NF or rejection otherwise.

As shown at 1007, the WTRU may establish the IPsec SA with the 6G PDG using the K6G PDG established as described above.

As shown at 1008, based on successful establishment of the IPsec SA between the WTRU and the 6G PDG, the WTRU may exchange traffic securely with the 6GC via the 6G PDG. For example, the WTRU may initiate any of NAS and UP communications (directly) with NFs over the secure IPsec tunnel. Information about NFs that the WTRU may communicate with may be received via the 6G PDG in a previous operation (e.g., as shown at 1006) or as part of this communication operation (shown at 1008).

WTRU connection establishment with 6G PDG (with no existing MAB context) is described herein.

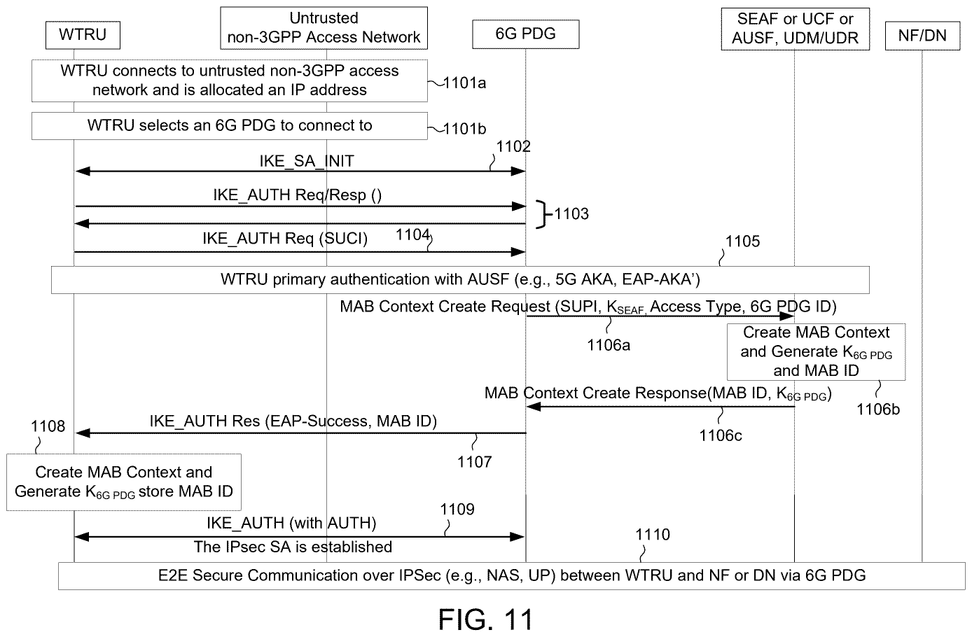

FIG. 11 is a diagram illustrating a second example procedure to establish a secure connection between the WTRU and the network over untrusted non-3GPP access using a 6G PDG as a network access security termination point. In the second example procedure, the WTRU may not have yet established any MAB context with the network.

Operations shown at 1101a, 1101b, 1102 and 1103 may be similar to the operations shown at 1001a, 1001b, 1002, and 1003 respectively.

As shown at 1104, with no locally stored MAB context associated with the PLMN, the WTRU may determine that this may be an initial connection with the PLMN and may generate a SUCI. The WTRU may send a first request message such as e.g., an IKE_AUTH request message indicating the SUCI to the 6G PDG.

As shown at 1105, based on receiving a SUCI in the first request message, the 6G PDG may initiate a primary authentication with the AUSF (e.g., based on any authentication methods such as e.g., any of 5G AKA and EAP-AKA). Upon successful authentication the 6G PDG may receive from the AUSF any of a SUPI and anchor key K_{SEAF}. In this example, the 6G PDG may act as the authenticator and may interact directly with AUSF. In another example the 6G PDG may use SEAF as an authenticator as described herein.

As shown at 1106a, the 6G PDG may act as or may select a MAB context holding NF (e.g., using routing indicator part of any of the SUCI, NRF). The 6G PDG may send a second request message (such as e.g., a MAB context create message) indicating any of the SUPI, K_{SEAF}, the access type (e.g., non-3GPP, Wi-Fi) along with the 6G PDG ID to the selected MAB context holding NF.

As shown at 1106b, the MAB context holding NF may create a (e.g., new) MAB context for the WTRU identified with the SUPI. The NF may initialize a NAC (e.g., with value zero), may generate a (e.g., new) K_{6G PDG}, a (e.g., new) MAB ID and may store the parameters in the MAB context (as described herein).

As shown at 1106c, the 6G PDG may receive from the MAB context holding NF a second response message (such as e.g., a MAB context create response) indicating any of the MAB ID and K_{6G PDG}.

As shown at 1107, the 6G PDG may send a first response message (such as e.g., an IKE_AUTH response message) to the WTRU including/indicating acceptance of the connection e.g., if a K_{6G PDG} is successfully received from the MAB context holding NF or rejection otherwise. The 6G PDG may include the MAB ID in the first response message.

As shown at 1108, the WTRU may generate a (e.g., new) K_{6G PDG} the same way as the network as shown at 1106b. The WTRU may store the received MAB ID and may create a (e.g., new) MAB context where the WTRU may store the MAB context parameters (e.g., NAC, as described herein).

Operations shown at 1109 and 1110 in FIG. 11 may be similar to operations shown at 1007 and 1008 in FIG. 10.

In an example, the 6G PDG may initiate the WTRU authentication through an authentication request message to SEAF (as part of operations shown at 1105). The SEAF acting as authenticator and MAB context holding NF, may create a MAB context locally based on receiving successful authentication result from AUSF (SUPI, K_{SEAF}) as shown at 1106b and may send the MAB ID and K_{6G PDG} to the 6G PDG in an authentication response message.

In an example, the AUSF may generate the K_{6G PDG} using K_{AUSF}. The AUSF may store the NAC and other MAB context parameters locally and/or use UDM/UDR or any other MAB context holding NF. In the procedure described above, the 6G PDG may receive any of the MAB ID and K_{6G PDG} from AUSF during WTRU network access procedure (e.g., as part of the operations shown at 1105 in FIG. 11 or as part of the operations resulting in successful prior network access of the pre-condition of FIG. 10).

In an example, the WTRU may use the MAB context established during the non-3GPP access (e.g., via a first (e.g., N3GPP) access network) for a subsequent connection (e.g., registration) with a PLMN over 3GPP access (e.g., via a second (e.g., 3GPP) access network). In that example, the WTRU may send a message (e.g., indicating a registration request) to the network anchor NF (e.g., AMF) including/indicating the MAB ID. The AMF may perform similar operations to the 6G PDG to obtain an access key (K_{AMF}) using the established MAB context in the network (e.g., in SEAF, AUSF).

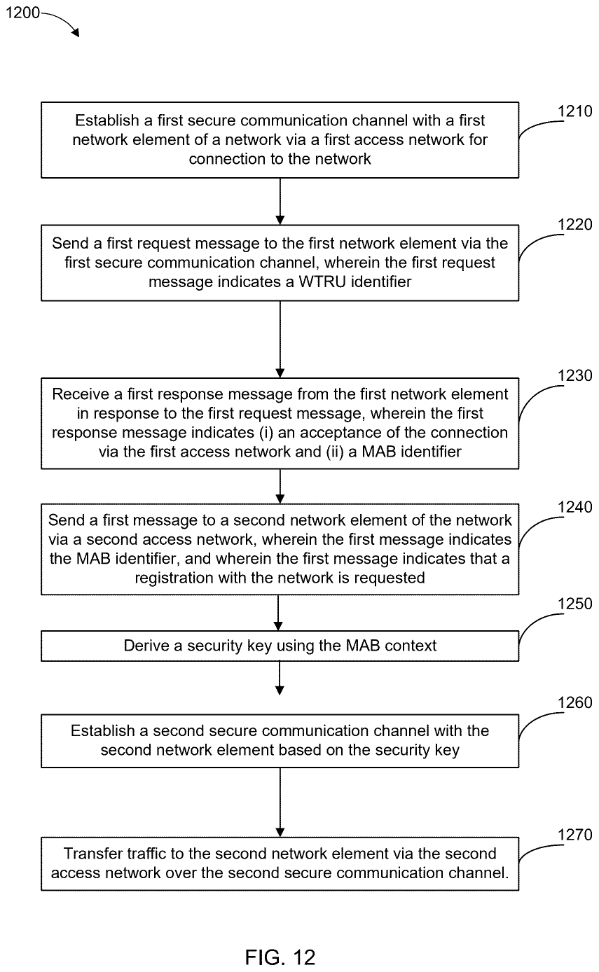

FIG. 12 is a diagram illustrating an example method for integrated and lean access security via a first non-3GPP access network and a second 3GPP access network; implemented in a WTRU. The WTRU may include circuitry including a transmitter, a receiver, a processor, and memory. The circuitry may be configured to carry out the method 1200. As shown at 1210, the method 1200 may include establishing a first secure communication channel with a first network element of a network via a first access network for connection to the network. As shown at 1220, the method 1200 may include sending a first request message to the first network element via the first secure communication channel. In various embodiments, the first request message may indicate a WTRU identifier. In various embodiments, the WTRU identifier may identify the WTRU. As shown at 1230, the method 1200 may include receiving a first response message from the first network element in response to the first request message. In various embodiments, the first response message may indicate any of (i) an acceptance of the connection via the first access network and (ii) a MAB identifier. In various embodiments, the MAB identifier may identify a MAB context associated with the WTRU. As shown at 1240, the method 1200 may include sending a first message to a second network element of the network via a second access network. In various embodiments, the first message may indicate the MAB identifier. In various embodiments, the first message may indicate that a registration with the network may be requested. As shown at 1250, the method 1200 may include deriving a security key using the MAB context. As shown at 1260, the method 1200 may include establishing a second secure communication channel with the second network element based on the security key. As shown at 1270, the method 1200 may include transferring traffic to the second network element via the second access network over the second secure communication channel.

In various embodiments, the traffic may include control plane traffic.

In various embodiments, the first network element may include a 6G PDG.

In various embodiments, the second network element may include an AMF.

In various embodiments, the first secure communication channel may include a secure IKE SA communication channel.

In various embodiments, the second secure communication channel may include a NAS connection.

In various embodiments, the first access network may be a non-3GPP access network and the second access network may be a 3GPP access network.

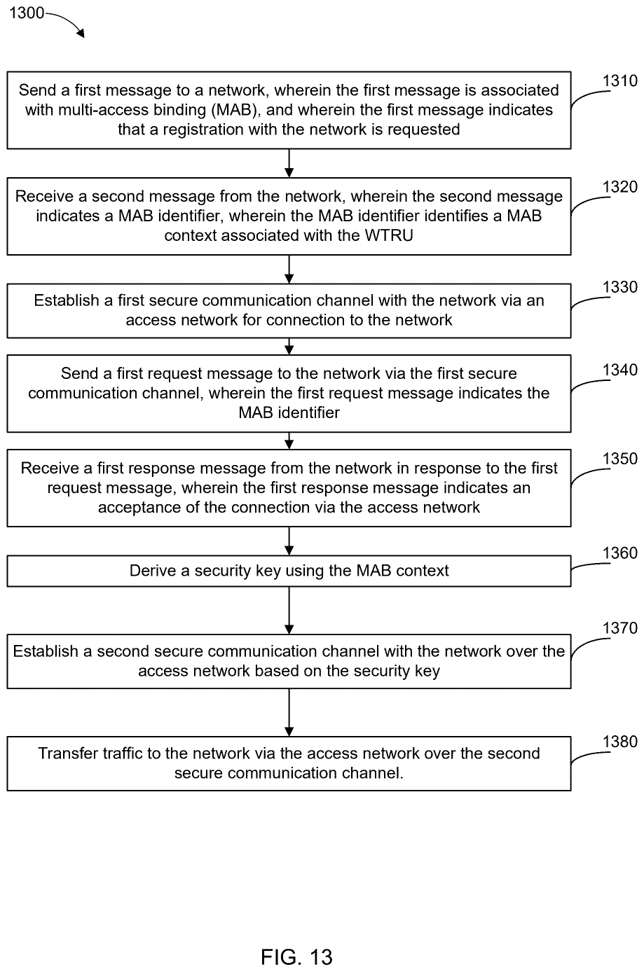

FIG. 13 is a diagram illustrating an example method 1300 for integrated and lean access security via non-3GPP access, implemented in a WTRU. The WTRU may include circuitry including a transmitter, a receiver, a processor, and memory. The circuitry may be configured to carry out the method 1300. As shown at 1310, the method 1300 may include sending a first message to a network. In various embodiments, the first message may be associated with multi-access binding (MAB). In various embodiments, the first message may indicate that a registration with the network may be requested. As shown at 1320, the method 1300 may include receiving a second message from the network. In various embodiments, the second message may indicate a MAB identifier based on successful WTRU authentication. In various embodiments, the MAB identifier may identify a MAB context associated with the WTRU. As shown at 1330, the method 1300 may include establishing a first secure communication channel with the network via an access network for connection to the network. As shown at 1340, the method 1300 may include sending a first request message to the network via the first secure communication channel. In various embodiments, the first request message may indicate the MAB identifier. As shown at 1350, the method 1300 may include receiving a first response message from the network in response to the first request message. In various embodiments, the first response message may indicate an acceptance of the connection via the access network. As shown at 1360, the method 1300 may include deriving a security key using the MAB context. As shown at 1370, the method 1300 may include establishing a second secure communication channel with the network over the access network based on the security key. In various embodiments, the second secure communication channel may be established within the first secure communication channel. As shown at 1380, the method 1300 may include transferring traffic to the network via the access network over the second secure communication channel.

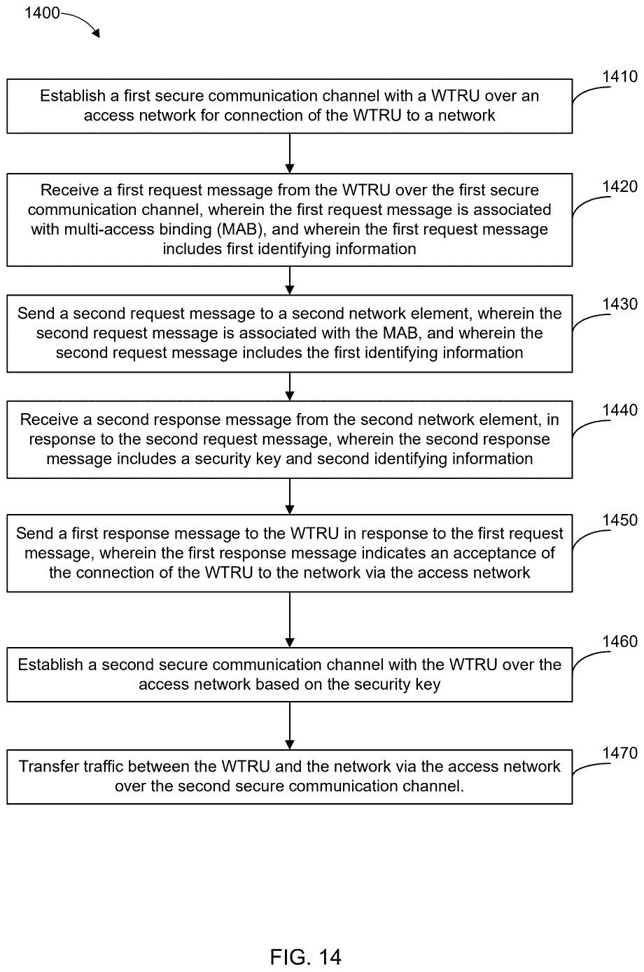

FIG. 14 is a diagram illustrating an example method 1400 for integrated and lean access security via non-3GPP access, implemented in a first network element. The first network element may include circuitry including a transmitter, a receiver, a processor, and memory. The circuitry may be configured to carry out the method 1400. As shown at 1410, the method 1400 may include establishing a first secure communication channel with a wireless transmit/receive unit (WTRU) over an access network for connection of the WTRU to a network. In various embodiments, the first network element may be connected to the network. As shown at 1420, the method 1400 may include receiving a first request message from the WTRU over the first secure communication channel. In various embodiments, the first request message may be associated with multi-access binding (MAB). In various embodiments, the first request message may include first identifying information. As shown at 1430, the method 1400 may include sending a second request message to a second network element. In various embodiments, the second request message may be associated with the MAB. In various embodiments, the second request message may include the first identifying information. As shown at 1440, the method 1400 may include receiving a second response message from the second network element in response to the second request message. In various embodiments, the second response message may include a security key and second identifying information. As shown at 1450, the method 1400 may include sending a first response message to the WTRU in response to the first request message. In various embodiments, the first response message may indicate an acceptance of the connection of the WTRU to the network via the access network based on the second response message indicating the security key. As shown at 1460, the method 1400 may include establishing a second secure communication channel with the WTRU over the access network based on the security key. In various embodiments, the second secure communication channel may be established within the first secure communication channel. As shown at 1470, the method 1400 may include transferring traffic between the WTRU and the network via the access network over the second secure communication channel.

In various embodiments, the first identifying information may include a WTRU identifier. In various embodiments, the WTRU identifier may identify the WTRU.

In various embodiments, the WTRU identifier may comprise a subscription concealed identifier (SUCI) of the WTRU.

In various embodiments, the second request message may indicate a request to create a MAB context associated with the WTRU. In various embodiments, the second request message may indicate the WTRU identifier.

In various embodiments, the second identifying information may include a MAB identifier. In various embodiments, the MAB identifier may identify a MAB context associated with the WTRU.

In various embodiments, the first response message may include the second identifying information.

In various embodiments, the first response message may include the MAB identifier.

In various embodiments, the first identifying information may include a MAB identifier. In various embodiments, the MAB identifier may identify a MAB context associated with the WTRU.

In various embodiments, the method 1400 may further include identifying, based on the MAB identifier, the second network element as comprising a MAB context holding network function.

In various embodiments, the second request message may indicate a request for the security key.

In various embodiments, the second identifying information may comprise a WTRU identifier. In various embodiments, the WTRU identifier may identify the WTRU.

In various embodiments, the WTRU identifier may comprise a subscription permanent identifier (SUPI) of the WTRU.

In various embodiments, MAB may be associated with maintaining information related one or more access networks used by the WTRU to connect to the network. In various embodiments, the information is maintained in the MAB context, the MAB context being identified by a MAB identifier.

In various embodiments, the MAB identifier may include any of (i) a network identifier, (ii) routing information to be used to locate a network function maintaining the MAB context, (iii) one or more access types being used by the WTRU, and (iv) a number used by the network to identify the MAB context associated with the WTRU, wherein the network identifier identifies the network.

In various embodiments, the MAB context may be associated with any of (i) a WTRU identifier, (ii) one or more access types, (iii) a network access counter, (iv) one or more network function identifiers identifying one or more network functions providing the WTRU with an anchor point to the network, (v) one or more keys, and (vi) a time stamp indicating a refresh time of the MAB context.

In various embodiments, the first request message may comprise an internet key exchange security association (IKE SA) authentication request message.

In various embodiments, the first response message may comprise an IKE SA authentication response message.

In various embodiments, the first network element may comprise a 6G PDG.

In various embodiments, the first secure communication channel and the second secure communication channel may comprise secure IKE SA communication channels.

In various embodiments, the second network element may comprise any of a security anchor function (SEAF), a WTRU context function (UCF), an authentication server function (AUSF), a unified data management (UDM) and a unified data repository (UDR).

In various embodiments, the access network may comprise a non-3GPP access network.

In various embodiments, the network may comprise a core network.

In various embodiments, the traffic may comprise any of control plane traffic and user plane traffic.

Any feature/characteristic/variant described in relation to (e.g., following the description of) the method 1400 implemented in the first network element and illustrated at FIG. 14 may also be applicable to any of the methods 1200 1300 implemented in a WTRU and illustrated at FIG. 12 and FIG. 13, and vice versa.

While not explicitly described, embodiments described herein may be employed in any combination or sub-combination. For example, the present principles are not limited to the described variants, and any arrangement of variants and embodiments can be used.

Besides, any characteristic, variant or embodiment described for a method is compatible with an apparatus device comprising means for processing the disclosed method, with a device comprising circuitry, including any of a transmitter, a receiver, a processor, and memory, the circuitry being operable (e.g., configured) to process the disclosed method, with a computer program product comprising program code instructions and with a non-transitory computer-readable storage medium storing program instructions. Besides, any characteristic, variant or embodiment described for a WTRU is compatible with an (e.g., infrastructure) network element of the cellular network.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

The content of each of the following references is incorporated by reference herein in its entirety:
3GPP Technical Specification TS 23.501 “Technical Specification Group Services and System Aspects; System architecture for the 5G System (5GS); Stage 2 (Release 19)”, v19.3.0;
3GPP TS 33.501 “Technical Specification Group Services and System Aspects, “Security Architecture and Procedures for 5G System”, (Release 19)”, v19.2.0;
3GPP TS 23.402 “Technical Specification Group Services and System Aspects; Architecture enhancements for non-3GPP accesses (Release 18)”, v18.3.0;
S2-2501462, Qualcomm Incorporated, “New SID on Enhancements for ePDG based access to 5GC”, 3GPP TSG-SA WG2 #167, Athens, Greece, 17-21 Feb. 2025;
Internet Engineering Task Force (IETF), RFC 7296, KAUFMAN C. et al., “Internet Key Exchange Protocol Version 2”.

What is claimed is:

1. A first network element comprising circuitry, including a transmitter, a receiver, a processor, and memory, configured to:
establish a first secure communication channel with a wireless transmit/receive unit (WTRU) over an access network for connection of the WTRU to a network, wherein the first network element is connected to the network;
receive a first request message from the WTRU over the first secure communication channel, wherein the first request message is associated with multi-access binding (MAB), and wherein the first request message includes first identifying information;
send a second request message to a second network element, wherein the second request message is associated with the MAB, and wherein the second request message includes the first identifying information;
receive a second response message from the second network element in response to the second request message, wherein the second response message includes a security key and second identifying information;
send a first response message to the WTRU in response to the first request message, wherein the first response message indicates an acceptance of the connection of the WTRU to the network via the access network based on the second response message indicating the security key;
establish a second secure communication channel with the WTRU over the access network based on the security key, wherein the second secure communication channel is established within the first secure communication channel; and
transfer traffic between the WTRU and the network via the access network over the second secure communication channel.

2. The first network element of claim 1, wherein the first identifying information includes a WTRU identifier, wherein the WTRU identifier identifies the WTRU.

3. The first network element of claim 2, wherein the WTRU identifier comprises a subscription concealed identifier (SUCI) of the WTRU.

4. The first network element of claim 2, wherein the second request message indicates a request to create a MAB context associated with the WTRU, and wherein the second request message indicates the WTRU identifier.

5. The first network element of claim 2, wherein the second identifying information includes a MAB identifier, and wherein the MAB identifier identifies a MAB context associated with the WTRU.

6. The first network element of claim 2, wherein the first response message includes the second identifying information.

7. The first network element of claim 1, wherein the first identifying information includes a MAB identifier, and wherein the MAB identifier identifies a MAB context associated with the WTRU.

8. The first network element of claim 7, further configured to identify, based on the MAB identifier, the second network element as comprising a MAB context holding network function.

9. The first network element of claim 7, wherein the second request message indicates a request for the security key.

10. The first network element of claim 7, wherein the second identifying information comprises a WTRU identifier, wherein the WTRU identifier identifies the WTRU.

11. The first network element of claim 10, wherein the WTRU identifier comprises a subscription permanent identifier (SUPI) of the WTRU.

12. The first network element of claim 1, wherein MAB is associated with maintaining information related one or more access networks used by the WTRU to connect to the network, wherein the information is maintained in a MAB context, and wherein the MAB context is identified by a MAB identifier.

13. The first network element of claim 12, wherein the MAB identifier includes any of (i) a network identifier, (ii) routing information to be used to locate a network function maintaining the MAB context, (iii) one or more access types being used by the WTRU, and (iv) a number used by the network to identify the MAB context associated with the WTRU, wherein the network identifier identifies the network.

14. The first network element of claim 12, wherein the MAB context is associated with any of (i) a WTRU identifier, (ii) one or more access types, (iii) a network access counter, (iv) one or more network function identifiers identifying one or more network functions providing the WTRU with an anchor point to the network, (v) one or more keys, and (vi) a time stamp indicating a refresh time of the MAB context.

15. The first network element of claim 1, wherein the first request message comprises an internet key exchange security association (IKE SA) authentication request message.

16. The first network element of claim 1, wherein the first response message comprises an IKE SA authentication response message.

17. The first network element of claim 1, wherein the first network element comprises a 6G packet data gateway (6G PDG).

18. The first network element of claim 1, wherein the first secure communication channel and the second secure communication channel comprise secure IKE SA communication channels.

19. A method implemented in a first network element, the method comprising:
establishing a first secure communication channel with a wireless transmit/receive unit (WTRU) over an access network for connection of the WTRU to a network, wherein the first network element is connected to the network;
receiving a first request message from the WTRU over the first secure communication channel, wherein the first request message is associated with multi-access binding (MAB), and wherein the first request message includes first identifying information;
sending a second request message to a second network element, wherein the second request message is associated with the MAB, and wherein the second request message includes the first identifying information;
receiving a second response message from the second network element, in response to the second request message, wherein the second response message includes a security key and second identifying information;
sending a first response message to the WTRU in response to the first request message, wherein the first response message indicates an acceptance of the connection of the WTRU to the network via the access network based on the second response message indicating the security key;
establishing a second secure communication channel with the WTRU over the access network based on the security key, wherein the second secure communication channel is established within the first secure communication channel; and
transferring traffic between the WTRU and the network via the access network over the second secure communication channel.

20. A wireless transmit/receive unit (WTRU) comprising circuitry, including a transmitter, a receiver, a processor, and memory, configured to:
send a first message to a network, wherein the first message is associated with multi-access binding (MAB), and wherein the first message indicates that a registration with the network is requested;
receive a second message from the network, wherein the second message indicates a MAB identifier based on successful WTRU authentication, wherein the MAB identifier identifies a MAB context associated with the WTRU;
establish a first secure communication channel with the network via an access network for connection to the network;
send a first request message to the network via the first secure communication channel, wherein the first request message indicates the MAB identifier;
receive a first response message from the network in response to the first request message, wherein the first response message indicates an acceptance of the connection via the access network;
derive a security key using the MAB context;
establish a second secure communication channel with the network over the access network based on the security key, wherein the second secure communication channel is established within the first secure communication channel; and
transfer traffic to the network via the access network over the second secure communication channel.

21-23. (canceled)
